(19) United States
(12) Patent Application Publication
(10) Pub. No.: US 2006/0033949 A1
(43) Pub. Date: Feb. 16, 2006

(54) Output device identification apparatus, control program for identifying the output device and method for identifying the output device

(75) Inventor: Masato Fujii, Nagaokakyo-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Konica Minolta Business Technologies, Inc., Tokyo (JP)

(21) Appl. No.: 11/002,760

(22) Filed: Dec. 3, 2004

(30) Foreign Application Priority Data
Aug. 11, 2004 (JP) 2004-234788

(51) Int. Cl. G06F 3/12

(52) U.S. Cl. 358/1.15

(57) ABSTRACT

The output device identification apparatus comprises a tentative job issuance portion for issuing a tentative job to any of a plurality of the output devices connected through a network, a historic information acquisition portion for obtaining a job historic information of a plurality of output devices that include an output device that executed the issued tentative job, and an address information acquisition portion for obtaining address information by identifying the output device that executed the tentative job based upon the job historic information of each output device obtained.

This application claims priority under 35 U.S.C. § 119 to Japanese Patent Application No. P2004-234788 filed on Aug. 11, 2004, the entire disclosure of which is incorporated herein by reference in its entirety.

### BACKGROUND OF THE INVENTION

1. Field of the Invention

The present invention relates to an output device identification apparatus, a control program for identifying the output device and a method for identifying the output device for obtaining a network address of the output device in a job processing system for issuing a job from a user terminal to the output device with the device connected to a plurality of the output devices through a network.

2. Description of the Related Art

The following description sets forth the inventor's knowledge of related art and problems therein and should not be construed as an admission of knowledge in the prior art.

In order to share a plurality of output devices such as a MFP (Multi Function Peripherals) or a printer with a plurality of user terminals, a system for job processing has been used in which such user terminals and out put devices are connected through the server and the network, and a variety of jobs including a printing job are issued from a user terminal though a server to a determined output device to execute a job.

In such a job processing system, as a job from a user terminal is sent to the server, and from the server to each output device, the user only need to execute the job based upon information on the output device obtained from the server, thus a need for a direct communication between the user terminal and the output device is eliminated. When the job is issued from the user terminal to the output device though the server, in particular, it needs no storage of address information of the output device in the user terminal in order to execute the job.

In recent years, with use of a device information collection oriented utility software such as an application using interactive communication libraries, various configuration information such as an operation status of the output device from the user terminal, the remaining amount of paper or the toner level are directly kept track of and managed.

In order for such administration, the user terminal should obtain the address information of the output device to directly communicate with the output device, however, the acquisition of the address information is not so easy as it should be obtained only through inquiring to the network administrators.

Additionally, Japanese Unexamined Patent Publication No. 2000-29653 describes a data processing system that informs a malfunction caused during the execution of a printing job through a printer to the user who issued the printing job. In this data processing system, when a printing job is issued from the user terminal to the printer that is connected to a network, a unique identification number that shows a sending party is provided on a job header in the printing job, and the printer analyzes and sustains the identification number. This allows sending of a message to the job sending party when any problem occurs during the job processing operation at the printer, by way of using the identification number.

The data processing system described in the above-mentioned patent publication is capable of receiving information of malfunctioning that is pertinent to the printing job sent from the user terminal, however, no information can be obtained from the printer when there are no malfunctions. Therefore the system has no technology to disclose that obtains the address information of the printer.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The preferred embodiments of the present invention can significantly improve upon existing methods and/or apparatuses.

Among other potential advantages, some embodiments can provide an output device identification apparatus for obtaining the address information by identifying the output device if necessary.

Among other potential advantages, some embodiments can provide a control program for identifying the output device that is capable of obtaining the address information by specifying the output device if necessary.

Among other potential advantages, some embodiments can provide a method for identifying the output device by specifying the output device if necessary.

According to a first aspect of a preferred embodiment of the present invention, an output device identification apparatus, comprises:
a tentative job issuance portion for issuing a tentative job to any of a plurality of the output devices connected through the network,
a job historic information acquisition portion for obtaining a job historic information of a plurality of output devices that includes an output device that executed the issued tentative job, and
an address information acquisition portion for obtaining the address information by identifying the output device that executed the tentative job based upon the job historic information of each output device obtained.

According to a second aspect of a preferred embodiment of the present invention, a control program for identifying the output device for computer execution, comprises the steps of:
issuing the tentative job to any of a plurality of output devices that are connected through the network,
obtaining the job historic information of a plurality of output devices that include the output device that executed the issued tentative job, and
obtaining address information by specifying the output device that executed the tentative job based upon the job historic information of each output device obtained.

According to a third aspect of a preferred embodiment of the present invention, a method for identifying the output device of the present invention, comprises the steps of:
issuing the tentative job to any of a plurality of output devices that are connected through the network,
obtaining the job historic information of a plurality of the output device that includes the output device that executed the issued tentative job,
obtaining the address information by specifying the output device that executed the tentative job based upon the job historic information of each output device obtained.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a block diagram illustrating a configuration of a network printing system utilizing an output identification apparatus of an embodiment of the present invention;

FIG. 2 is a block diagram functionally illustrating a configuration of a user terminal as an output device identification apparatus used in FIG. 1;

FIG. 3 is a drawing illustrating an example of the job historic information of the printer; and

FIG. 4 is a flow chart diagram illustrating a process of an output device identification process that is executed by the user terminal shown in FIG. 2.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

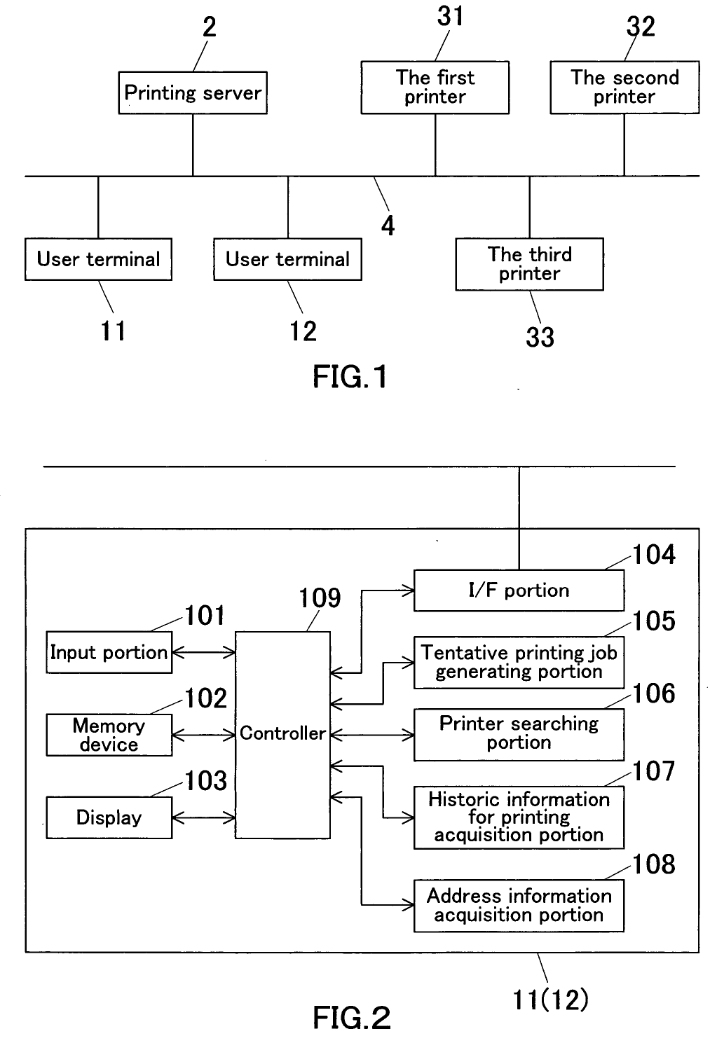

FIG. 1 is a block diagram illustrating a configuration of the network printing system utilizing the output identification apparatus of an embodiment of the present invention. In this embodiment, an example is described in which the output device is a printer.

In FIG. 1, reference numerals 11, 12 denote the user terminal as the output device identification apparatus comprised of a personal computer, for example. One or more computers are provided according to a number of the user. In this embodiment, two computers are used.

A reference numeral 2 denotes a printer server comprised of the similar personal computer, and the reference numerals 31 through 33 is printers as an output device. In this embodiment, three printers from the first to the third printers are used.

Additionally, the user terminals 11, 12, a printer server 2, and a first printer 31, a second printer 32, and a third printer 33 are connected with each other through a network 4. As the network 4 is a local area network (LAN), the user terminal 11, 12, the printer server 2, and the first printer 31, the second printer 32, and the third printer 33 are capable of communicating with each other in accordance with a TCP/IP (Transmission Control Protocol/Internet Protocol). This means that the specification of the IP address of the other party allows the establishment of a network connection with the other party.

The first printer 31, the second printer 32, and the third printer 33 are managed by the printer server 2. The printing job from the user terminal is therefore issued to the printing server 2, and each of the printers 31 though 33 receives the printing job from the printing server 2 for the print output.

FIG. 2 is a block diagram functionally illustrating an inner configuration of the user terminal 11, 12.

As shown in FIG. 2, the user terminal 11, 12 comprises an input portion 101, a memory device 102, a display 103, an interface portion (shown as I/F portion in the drawing) 104, a tentative printing job generating portion 105, a printer searching portion 106, a historic information for printing acquisition portion 107, an address information acquisition portion 108, and a controller 109.

The input portion 101 comprises a key board, a mouse, and such. The memory device 102 comprises a hard disk as such, for example, for storing a variety of data, programs and IP addresses of the printers. Details will be described later. The display 103 comprises a liquid crystal display device, CRT, and such.

The interface portion 104 functions as a sending and receiving portion to execute a communication between the printer server 2 and the printers 31 through 33.

The tentative printing job generating portion 105 generates a tentative printing job for obtaining an IP address that is address information of the printers 31 through 33. The generation of tentative printing job is executed in such a way shown below.

Users prepare a tentative document to be printed through the tentative printing job and have the memory device 102 to store the document. When the user instructs a generation of the tentative printing job, the tentative printing job generating portion 105 calls the tentative document stored in the memory device 102 and automatically prepare the user name, the user ID, the name of job (the name of document), etc to generate the tentative job.

The instruction for the generation of the tentative printing job by the user may be conducted through an operation of specific key in the input portion 101, or may have the instruction screen displayed on a display 103 and operate the instruction button on the screen.

The printer searching portion 106 searches all the printers connected to the network 4 upon the issuance of the tentative printing job. Such printer search is conducted via the SNMP (Simple Network Management Protocol) that is a network management protocol, for example. The search via the SNMP is conducted by a communication between the manager and the printer-resident agent, in which the agent replies a response to a request from the manager, thereby enabling the searching of the printers 31 through 33.

The historic information for printing acquisition portion 107 obtains historic information for printing that is a result of the job execution of the printers 31 through 33 searched by the printer searching portion 106. The acquisition of historic information for printing is achieved by having the MIB (Management Information Base) which is the management information database to be present at the printers 31 through 33 that corresponds to the SNMP, and by having the agent of the printers 31 through 33 send back the historic information for printing stored within the MIB with respect to a request from the manager in the user terminal.

The address information acquisition portion 108 analyzes the historic information for printing of each of the printers 31 through 33 that is obtained by the historic information for printing acquisition portion 107 to search the historic information for printing on the tentative printing job issued by the user terminal, and identifies the printer that executed the tentative printing job, and then obtain the IP address that is the address information of the printer.

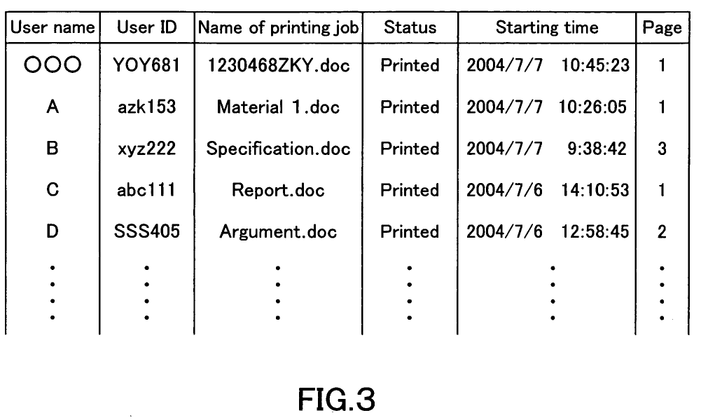

FIG. 3 shows an example of the historic information for printing obtained from the printers 31 through 33. The historic information for printing includes the user name, the user ID, the name of the printing job (the name of document), the status, the time to initiate the job, and number of pages. In this embodiment, the most recently executed job (a job shown at the top in FIG. 3) is assumed as a tentative printing job, and “1230468zky.doc” is designed as a name of the job and “∘∘∘” as a name of the user by the tentative printing job generating portion 105.

The controller 109 totally controls the entire part of the user terminals 11, 12. As for the function of the controller, it issues the printing job prepared by the user and the tentative printing job generated by the tentative printing job generating portion 105 to the print server 2 by an execution of the printer driver software through the interface 104. It sends the manager requests from the printer searching portion 106 and the historic information for printing acquisition portion 107 to the printers 31 through 33 via the interface portion 104, and it also sends a response received from the printers 31 through 33 to the printer searching portion 106 or the historic information for printing acquisition portion 107.

In addition, the tentative printing job generating portion 105, the printer searching portion 106, the historic information for printing acquisition portion 107, the address information acquisition portion 108, and the controller 109 may be configured by a computer system provided with the CPU and the memory. In this case, the system operates in a way that the CPU executes a control program for printer identification provided with the memory media and stored in the memory device 102.

The memory media includes a semiconductor memory such as a CD-ROM (Compact Disc Read Only Memory), a FD (Flexible Disc), a hard disc, a magnetic tape, a cassette tape, a laser disc, a MO (Magnetic Optical Disc)/MD (Mini Disc)/DVD (Digital Versatile Disc), an IC card (including a memory card), a laser card, a mask ROM, an EPROM, an EEPROM, and a flush ROM.

The printing job is sent from the user terminals 11, 12 shown in FIG. 2 to the printers 31 through 33 via the printer server 2 in this embodiment. As the printers 31 through 33 are managed by the printer server 2, the printing job can be executed even if the user terminals 11, 12 does not store the IP addresses of the each printer 31, 32 and 33.

When directly managing the configuration information such as the operation status, the remaining amount of paper or the toner level of the printers 31 through 33 from the user terminals 11, 12, the user terminal 11, 12 and the printers 31 through 33 should directly communicate with each other. This requires that the terminals 11, 12 store the IP address of the printers 31 through 33.

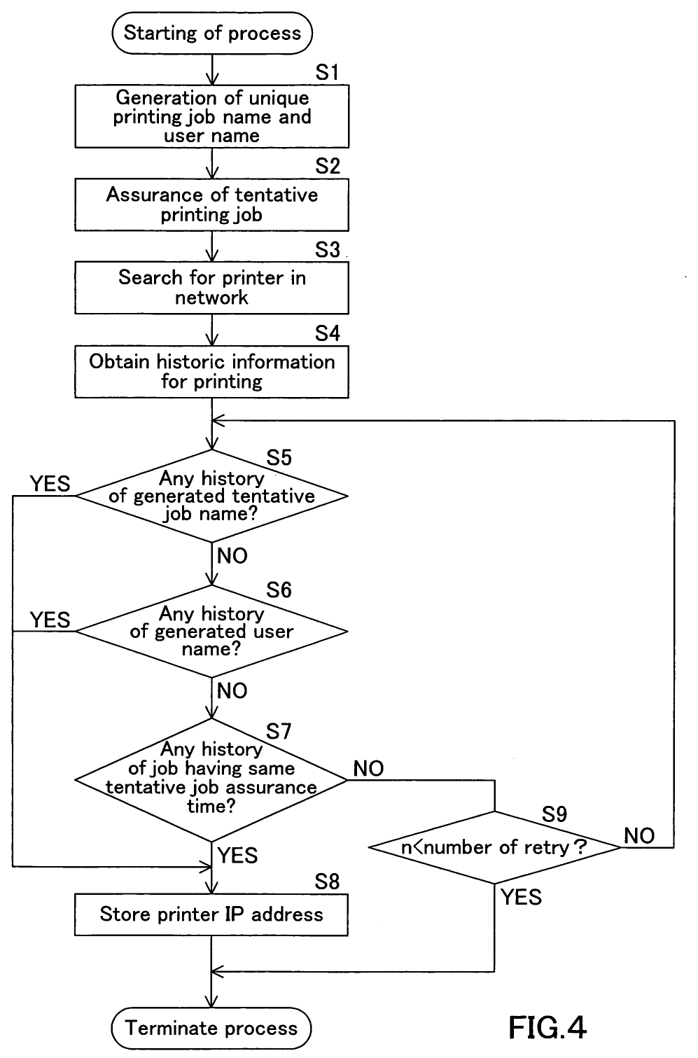

The process of obtaining the IP address of the printers 31 through 33 through the user terminal (user terminal 11, for example) is described below with a reference to the flow chart shown in FIG. 4. Each step is abbreviated as an “S” in the description below and in FIG. 4.

When the instruction for the IP address acquisition is given by the user, the tentative printing job generating portion 105 generates a tentative printing job with the name of the printing job and the name of the user thereon in the S1. It is preferable that a unique name of the printing job and the name of the user are determined as much as possible to avoid overlapping with other printing jobs and users. A possible unique job name to each job can be the names of the computer of the user terminal, a combination of an IP address of the user terminal 11, 12 and a log-in name, or a combination of a log-in name and a time, for example.

The controller 109 specifies any one of the printer 31 through 33 and sends the generated tentative printing job to the printing server 2 at S2.

The tentative printing job sent to the printing server 2 is sent to the printer (printer 31 for example) specified from the user and executed at there. Upon the execution of a tentative printing job, the execution result is recorded as job historic information at the printer 31.

Upon the issuance of the tentative printing job, the printer searching portion 106 of the user terminal 11 searches all of the printers 31 through 33 connected to the network 4 by the SNMP or such in the S3. The historic information for printing acquisition portion 107 obtains each of the printing historic information on all of the searched printers 31 through 33 in the S4 by utilizing the MIB and such. At this point, IP addresses on all of the printers 31 through 33 are obtained, however, the correspondence relationship between the printer and the IP address is remained unclear.

The address information acquisition portion 108 determines whether a job that is the same job name as the tentative printing job generated by the tentative printing job generating portion 105 exists in the historic information in the S5. In a case where a job having the same job name as the tentative printing job exists in the historic information (when the S5 determines YES), the address information acquisition portion 108 identifies the printer 31 that executed the tentative printing job as the printer it searched for, and proceeds to the S8, where the IP address corresponding to the printer 31 is stored in the memory device 102 to terminate the process.

In a case where a job having a same job name as the tentative printing job does not exist in the historic information in the S5 (when the S5 determines NO), the address information acquisition portion 108 determines whether a job having a same user name as the tentative printing job exists in the historic information in the S6. In a case where a job having a same user name as the tentative printing job exists in the historic information (when the S6 determines YES), the address information acquisition portion 108 identifies the printer 31 that executed the tentative printing job as the printer it searched for, and proceeds to the S8, where the IP address corresponding to the printer 31 is stored in the memory device to terminate the process.

When a job having a user name similar to the tentative printing job does not exist in the historic information (when the S6 determines NO) in the S6, it determines whether a job having a starting date in agreement with the issuance date of the tentative printing job exists or not in the S7. In a case where a job having a starting date in agreement with the issuance date of the tentative printing job exists (when S7 determines YES) in the S7, the address information acquisition portion 108 identifies the printer 31 that executed the tentative printing job as the printer it searched for, and proceeds to the S8, where the IP address corresponding to the printer 31 is stored in the memory device to terminate the process.

When a job having a starting date in agreement with the issuance date of the tentative printing job does not exist (when S7 determines NO) in the S7, it proceeds to the S9 and repeats the determination process of S5 to S7 until the number of retry reaches to the predetermined number n (when S9 determines NO). When the number of retry reaches to the predetermined number n (when S9 determines YES), it determines the process as a failure of the identification of the printer that executed the tentative printing job, and terminates the process.

In this embodiment, in the S5, the system determines whether a job having a job name similar to a tentative printing job generated in the tentative printing job generating portion 105 exists or not in the historic information. In a case where the job having the job name similar to the tentative printing job does not exist in the historic information, the system determines whether the job having the user name similar to the tentative printing job exists in the historic information in the S6. The system still determines whether a job having a starting date similar to an issuance date of the tentative printing job in the S7. This allows the identification of the printer and the execution of the acquisition process of the IP address in either types of the printers, one of which can store the name of the user although the name of the job cannot be stored, while the other type of the printer cannot store either the name of the user or the name of the job, but can store the time to initiate the job. Both types of the printer fail to store the complete data due to the limited memory capacity of the printing historic information.

The IP address of the printer 31 that executes the tentative printing job is obtained in such a way described above. In a case where other printers need to obtain the IP address, the tentative printing job may be issued for the printer as in a way shown above to execute the process shown in FIG. 4, and in a case where all of the printers 31 to 33 obtain the IP address, each printer may repeat the process shown in FIG. 4.

Upon the acquisition of the IP address of the printers 31 to 33, the user terminals 11, 12 can directly communicate with the printer. This enables the user terminals 11, 12 to directly obtain the information on the printer except for the information stipulated in the printing protocol from the printer. When the user terminals 11, 12 receives the operation status of the printers 31 through 33, the user terminals 11, 12 can manage the printer individually at the user terminals 11, 12. The information that the user terminals 11, 12 directly obtains from the printers 31 through 33 includes the operation status, the status of the optional equipment installed in the printer, the size of the paper set to the printer, the remaining amount of paper of each size, the toner level, the number of copy printed at the printer, setting information of the printer at the network, printing default setting, etc.

One embodiment of the present invention has been described above, however, the present invention shall not be limited to the above embodiment. The name of the job of the tentative printing job and the name of the user are automatically set by the tentative printing job generating portion 105 of the user terminals 11, 12 in the above embodiment, however, the generation of the tentative printing job including the name of the job or the name of the user may be conducted by the user, and the process after the issuance of the tentative printing job generated may be conducted by the user terminals 11, 12.

The printers 31 through 33 has been shown as an output device in this embodiment, however, it may be facsimile or any other devices.

The present invention has described a case wherein a job is issued from the user terminal to the output device through the server, however, even in the case wherein the job is directly issued from the user terminal to the output device without the server, the tentative job is issued and the IP address of the output device is obtained based upon the job historic information on the output device to easily obtain the IP address as shown in above.

In other words, when a job is directly issued from the user terminal to the printer without the server, it is possible to search the IP address from the port information, and so on. However, if the IP address is obtained as described in this embodiment, an unskilled user, who is not familiar with a computer and does not know how to obtain the port information, can easily search the address.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

What is claimed is:

1. An output device identification apparatus, comprising:
a tentative job issuance portion for issuing a tentative job to any one of a plurality of output devices connected through a network,
a historic information acquisition portion for obtaining a job historic information of a plurality of the output devices including said output device that executed said issued tentative job, and
an address information acquisition portion for obtaining address information by identifying the output device that executed said tentative job based upon said job historic information of each output device obtained.

2. The output device identification apparatus as recited in claim 1, wherein said address information acquisition portion identifies an output device that executed the tentative job based upon at least any one of a name of the tentative job, a name of a user who issued the tentative job, or an issuance time for the tentative job.

3. The output device identification apparatus as recited in claim 1, wherein the issuance of the tentative job to the output device is conducted through the server.

4. The output device identification apparatus as recited in claim 1, wherein the issuance of the tentative job to the output device is directly conducted without a server.

5. The output device identification apparatus as recited in claim 1, wherein the output device is a printer.

6. A control program for identifying the output device for computer execution, comprising the steps of:
issuing the tentative job to any of a plurality of output devices connected through a network;
obtaining the job historic information of said plurality of output devices including output devices that executed said issued tentative job; and
obtaining address information by identifying the output device that executed said tentative job based upon job historic information of each obtained output device.

7. A control program for identifying the output device as recited in claim 6, wherein the output device that executed the tentative job is identified based upon at least any of a name of the tentative job, a name of a user who issued the tentative job, an issuance time for the tentative job in the step of obtaining a network address.

8. A control program for identifying the output device as recited in claim 6, wherein the issuance of the tentative job is conducted through the server.

9. A control program for identifying the output device as recited in claim 6, wherein the issuance of the tentative job is conducted without the server.

10. A control program for identifying the output device as recited in claim 6, wherein the output device is the printer.

11. A method for identifying the output device, comprising the steps of:
issuing the tentative job to any of a plurality of output devices connected through the network;
obtaining the job historic information of said plurality of output devices including the output device that executed said issued tentative job; and
obtaining address information by identifying an output device that executed said tentative job based upon job historic information of each obtained output devices.

12. A method for identifying the output device as recited in claim 11, wherein the output device that executed the tentative job is identified based upon at least any of the name of the tentative job, the name of the user who issued the tentative job, the issuance time for the tentative job in the step of obtaining the network address.

13. A method for identifying the output device as recited in claim 11, wherein the issuance of the tentative job is conducted through the server.

14. A method for identifying the output device as recited in claim 11, wherein the issuance of the tentative job is conducted without the server.

15. A method for identifying the output device as recited in claim 11, wherein the output device is the printer.
